(19) United States
(12) Patent Application Publication
(10) Pub. No.: US 2020/0310420 A1
(43) Pub. Date: Oct. 1, 2020

(54) SYSTEM AND METHOD TO TRAIN AND SELECT A BEST SOLUTION IN A DYNAMICAL SYSTEM

(71) Applicant: GM GLOBAL TECHNOLOGY OPERATIONS LLC, Detroit, MI (US)

(72) Inventors: Ruggero Scorcioni, New York, NY (US); Rajan Bhattacharyya, Sherman Oaks, CA (US)

(21) Appl. No.: 16/365,434

(22) Filed: Mar. 26, 2019

(51) Int. Cl. G05D 1/00; G05D 1/02

(52) U.S. Cl. CPC G05D 1/0088; G05D 2201/0213; G05D 1/0221

(57) ABSTRACT

An autonomous vehicle, system and method for operating the autonomous vehicle. The system includes a plurality of solution modules, a state module, a hypothesis resolver and a navigation module. The plurality of solution modules each provide a solution for a future state of an agent. The state module that provides an environmental state. The hypothesis resolver receives the environmental state and the plurality of solutions, selects a solution from the plurality of solutions based on the environmental state and determines a reward for the solution, the reward indicating a confidence level of the solution for the environmental state. The navigation module navigates the autonomous vehicle based on the selected solution.

### INTRODUCTION

The subject disclosure relates to autonomous vehicles and, in particular, to a system and method for training a cognitive processor associated with the autonomous vehicle to select an optimal solution for agent behavior in dynamically changing scenarios and/or conditions.

Autonomous vehicles are intended to move a passenger from one place to another with no or minimal input from the passenger. Such vehicles require the ability to obtain knowledge about agents (i.e., other vehicles, pedestrians, bicyclists, etc.) in its environment and their possible motions and to calculate a trajectory for the autonomous vehicle based on this knowledge. A cognitive processor associated with the autonomous vehicle includes a plurality a hypothesizers, each of which predict a possible future trajectory of various agents in the environment. In general, each hypothesizer will predict one trajectory per agent. So, if N hypothesizers are executed over M agents then there will a total of N potential future trajectories per agent. A hypothesis resolver is then used to select one out of N of these predictions as the optimal solution for each of the agent. For example, given a pedestrian P at an intersection we could have 3 hypothesizers each predicting a different (or same) outcome: P stops and waits for crossing, P walks directly into the intersection, P keeps walking on the sidewalk. The hypothesis resolver responsibility is to select which of the 3 possible solutions is the most likely given current and past information. The selected solution is then used in order to determine a course of action for the autonomous vehicle. Each hypothesis that is submitted to the hypothesis resolver can be optimal for one set of conditions while not for another set of conditions. There is therefore a need to be able to select the prediction that most accurately describes the future motions of agents (e.g. vehicles, pedestrians, animals, bicyclists, etc.) based on past motions, current motions and other environmental conditions.

### SUMMARY

In one exemplary embodiment, a method of operating an autonomous vehicle is disclosed. A plurality of solutions for a future state of an agent is received at a hypothesis resolver. An environmental state is received at the hypothesis resolver. A solution is selected from the plurality of solutions based on the environmental state and a reward associated with each of the solutions, the reward indicating a confidence level of the solution for the environmental state. The autonomous vehicle is navigated based on the selected solution.

In addition to one or more of the features described herein, the environmental state includes at least one of a weather condition, a traffic pattern, a traffic rule and a road condition. The method further includes training the hypothesis resolver during a training mode to associate rewards with each of the solutions for a selected environmental state. The method further includes training the hypothesis resolver during a training mode by predicting a state of the agent at a selected future time for a solution and the received environmental state, measuring the actual state of the agent at the selected future time, determining an error for the solution based on predicted state and the actual state, and assigning the reward to the solution based on the error. The reward is inversely proportional to the error. The method further includes adjusting the reward of a solution to avoid overfitting of the solution to the environmental state. The error is determined from a Euclidean distance between the predicted state and the actual state.

In another exemplary embodiment, a system for operating an autonomous vehicle is disclosed. The system includes a plurality of solution modules, a state module, a hypothesis resolver and a navigation module. The plurality of solution modules each provide a solution for a future state of an agent. The state module that provides an environmental state. The hypothesis resolver receives the environmental state and the plurality of solutions, selects a solution from the plurality of solutions based on the environmental state and determines a reward for the solution, the reward indicating a confidence level of the solution for the environmental state. The navigation module navigates the autonomous vehicle based on the selected solution.

In addition to one or more of the features described herein, the environmental state includes at least one of a weather condition, a traffic pattern, a traffic rule and a road condition. The system further includes a neural network for training hypothesis resolver during a training mode to associate rewards with each of the plurality of solutions for a selected environmental state. The neural network trains the hypothesis resolver during the training mode by predicting a state of the agent at a selected future time for a solution and the received environmental state, measuring the actual state of the agent at the selected future time, determining an error for the solution based on predicted state and the actual state, and assigning the reward to the solution based on the error. The reward is inversely proportional to the error. The hypothesis resolver adjusts the reward of a solution to avoid overfitting of the solution to the environmental state. The error is determined from a Euclidean distance between the predicted state and the actual state.

In another exemplary embodiment, an autonomous vehicle is disclosed. The autonomous vehicle includes a plurality of solution modules, a state module, a hypothesis resolver and a navigation module. The plurality of solution modules each provide a solution for a future state of an agent. The state module provides an environmental state. The hypothesis resolver receives the environmental state and the plurality of solutions, selects a solution from the plurality of solutions based on the environmental state and determines a reward for the solution, the reward indicating a confidence level of the solution for the environmental state. The navigation module navigates the autonomous vehicle based on the selected solution.

In addition to one or more of the features described herein, the environmental state includes at least one of a weather condition, a traffic pattern, a traffic rule and a road condition. The autonomous vehicle further includes a neural network for training hypothesis resolver during a training mode to associate rewards with each of the plurality of solutions for a selected environmental state. The neural network trains the hypothesis resolver during the training mode by predicting a state of the agent at a selected future time for a solution and the received environmental state, measuring the actual state of the agent at the selected future time, determining an error for the solution based on predicted state and the actual state, and assigning the reward to the solution based on the error. The reward is inversely proportional to the error. The hypothesis resolver adjusts the reward of a solution to avoid overfitting of the solution to the environmental state.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with an associated trajectory planning system depicted in accordance with various embodiments;

FIG. 2 shows an illustrative control system including a cognitive processor integrated with an autonomous vehicle or vehicle simulator;

FIG. 3 shows a schematic diagram of a hypothesis resolver that operates to predict agent states from a plurality of hypothesis objects or solutions that are provided to the hypothesis resolver;

FIG. 4 shows an illustrative traffic scenario suitable for use in training a hypothesis resolver;

FIG. 5 shows a flowchart illustrating a training mode of the hypothesis resolver; and

FIG. 6 shows a flowchart illustrating an operating mode of the hypothesis resolver.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

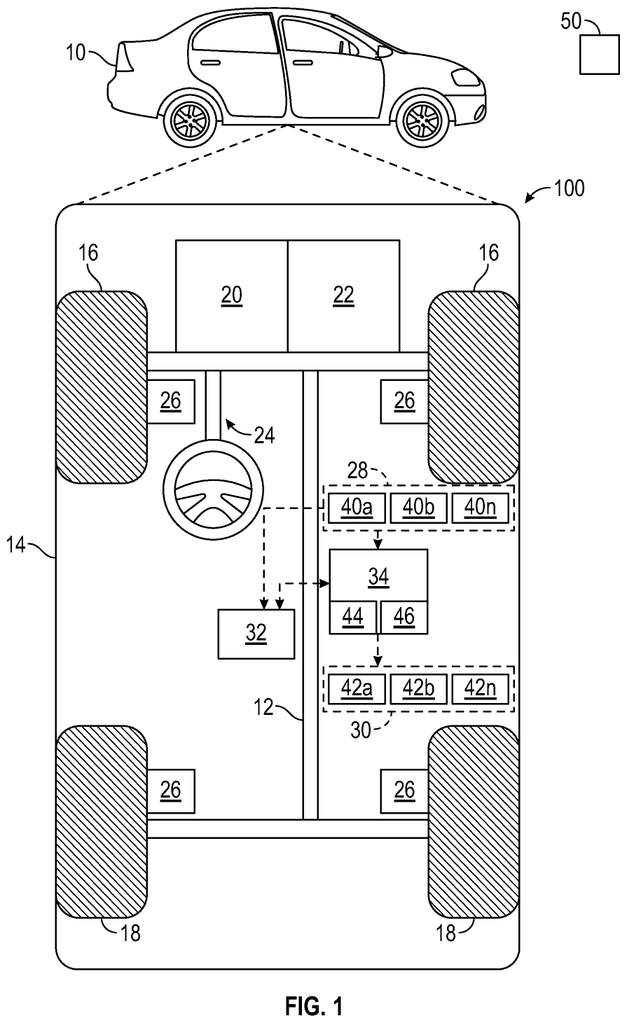

In accordance with an exemplary embodiment, FIG. 1 shows an autonomous vehicle 10 with an associated trajectory planning system depicted at 100 in accordance with various embodiments. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The wheels 16 and 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle has different levels of intervention or control of the vehicle through coupled assistive vehicle control all the way to full control of all vehicle functions. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, a cognitive processor 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms.

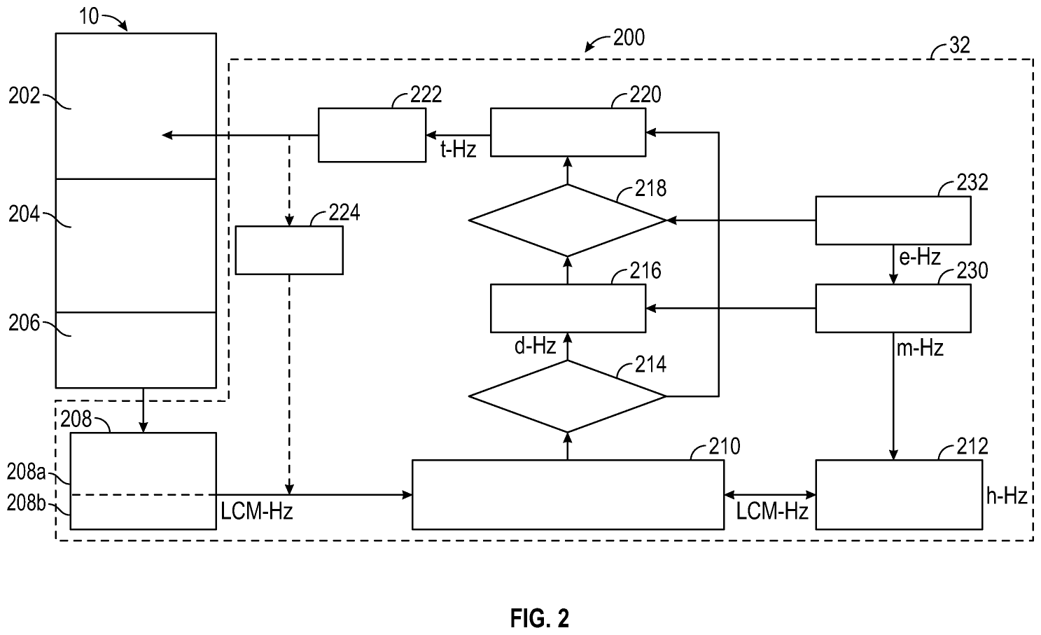

The controller 34 is further in communication with the cognitive processor 32. The cognitive processor 32 receives various data from the controller 34 and from the sensing devices 40a-40n of the sensor system 28 and performs various calculations in order to provide a trajectory to the controller 34 for the controller to implement at the autonomous vehicle 10 via the one or more actuator devices 42a-42n. A detailed discussion of the cognitive processor 32 is provided with respect to FIG. 2.

FIG. 2 shows an illustrative control system 200 including a cognitive processor 32 integrated with an autonomous vehicle 10. In various embodiment the autonomous vehicle 10 can be a vehicle simulator that simulates various driving scenarios for the autonomous vehicle 10 and simulates various response of the autonomous vehicle 10 to the scenarios.

The autonomous vehicle 10 includes a data acquisition system 204 (e.g., sensors 40a-40n of FIG. 1). The data acquisition system 204 obtains various data for determining a state of the autonomous vehicle 10 and various agents in the environment of the autonomous vehicle. Such data includes, but is not limited to, kinematic data, position or pose data, etc., of the autonomous vehicle 10 as well as data about other agents, including as range, relative speed (Doppler), elevation, angular location, etc. The autonomous vehicle 10 further includes a sending module 206 that packages the acquired data and sends the packaged data to the communication interface 208 of the cognitive processor 32, as discussed below. The autonomous vehicle 10 further includes a receiving module 202 that receives operating commands from the cognitive processor 32 and performs the commands at the autonomous vehicle to navigate the autonomous vehicle. The cognitive processor 32 receives the data from the autonomous vehicle 10, computes a trajectory for the autonomous vehicle based on the provided state information and the methods disclosed herein and provides the trajectory to the autonomous vehicle at the receiving module 202. The autonomous vehicle 10 then implements the trajectory provided by the cognitive processor 32.

The cognitive processor 32 includes various modules for communication with the autonomous vehicle 10, including an interface module 208 for receiving data from the autonomous vehicle and a trajectory sender 222 for sending instructions, such as a trajectory to the autonomous vehicle 10. The cognitive processor 32 further includes a working memory 210 that stores various data received from the autonomous vehicle 10 as well as various intermediate calculations of the cognitive processor 32. A hypothesizer module(s) 212 of the cognitive processor 32 is used to propose various hypothetical trajectories and motions of one or more agents 50 in the environment of the autonomous vehicle 10 using a plurality of possible prediction methods and state data stored in working memory 210. A hypothesis resolver 214 of the cognitive processor 32 receives the plurality of hypothetical trajectories for each agent 50 in the environment and determines a most likely trajectory for each agent from the plurality of hypothetical trajectories.

The cognitive processor 32 further includes one or more decider modules 216 and a decision resolver 218. The decider module(s) 216 receives the most likely trajectory for each agent 50 in the environment from the hypothesis resolver 214 and calculates a plurality of candidate trajectories and behaviors for the autonomous vehicle 10 based on the most likely agent trajectories. Each of the plurality of candidate trajectories and behaviors is provided to the decision resolver 218. The decision resolver 218 selects or determines an optimal or desired trajectory and behavior for the autonomous vehicle 10 from the candidate trajectories and behaviors.

The cognitive processor 32 further includes a trajectory planner 220 that determines an autonomous vehicle trajectory that is provided to the autonomous vehicle 10. The trajectory planner 220 receives the vehicle behavior and trajectory from the decision resolver 218, an optimal hypothesis for each agent 50 from the hypothesis resolver 214, and the most recent environmental information in the form of “state data” to adjust the trajectory plan. This additional step at the trajectory planner 220 ensures that any anomalous processing delays in the asynchronous computation of agent hypotheses is checked against the most recent sensed data from the data acquisition system 204. This additional step updates the optimal hypothesis accordingly in the final trajectory computation in the trajectory planner 220.

The determined vehicle trajectory is provided from the trajectory planner 220 to the trajectory sender 222 which provides a trajectory message to the autonomous vehicle 10 (e.g., at controller 34) for implementation at the autonomous vehicle.

The cognitive processor 32 further includes a modulator 230 that controls various limits and thresholds for the hypothesizer module(s) 212 and decider module(s) 216. The modulator 230 can also apply changes to parameters for the hypothesis resolver 214 to affect how it selects the optimal hypothesis object for a given agent 50, deciders, and the decision resolver. The modulator 230 is a discriminator that makes the architecture adaptive. The modulator 230 can change the calculations that are performed as well as the actual result of deterministic computations by changing parameters in the algorithms themselves.

An evaluator module 232 of the cognitive processor 32 computes and provides contextual information to the cognitive processor including error measures, hypothesis confidence measures, measures on the complexity of the environment and autonomous vehicle 10 state, performance evaluation of the autonomous vehicle given environmental information including agent hypotheses and autonomous vehicle trajectory (either historical, or future). The modulator 230 receives information from the evaluator 232 to compute changes to processing parameters for hypothesizers 212, the hypothesis resolver 214, the deciders 216, and threshold decision resolution parameters to the decision resolver 218. A virtual controller 224 implements the trajectory message and determines a feedforward trajectory of various agents 50 in response to the trajectory.

Modulation occurs as a response to uncertainty as measured by the evaluator module 232. In one embodiment, the modulator 230 receives confidence levels associated with hypothesis objects. These confidence levels can be collected from hypothesis objects at a single point in time or over a selected time window. The time window may be variable. The evaluator module 232 determines the entropy of the distribution of these confidence levels. In addition, historical error measures on hypothesis objects can also be collected and evaluated in the evaluator module 232.

These types of evaluations serve as an internal context and measure of uncertainty for the cognitive processor 32. These contextual signals from the evaluator module 232 are utilized for the hypothesis resolver 214, decision resolver, 218, and modulator 230 which can change parameters for hypothesizer modules 212 based on the results of the calculations.

The various modules of the cognitive processor 32 operate independently of each other and are updated at individual update rates (indicated by, for example, LCM-Hz, h-Hz, d-Hz, e-Hz, m-Hz, t-Hz in FIG. 2).

In operation, the interface module 208 of the cognitive processor 32 receives the packaged data from the sending module 206 of the autonomous vehicle 10 at a data receiver 208a and parses the received data at a data parser 208b. The data parser 208b places the data into a data format, referred to herein as a property bag, that can be stored in working memory 210 and used by the various hypothesizer modules 212, decider modules 216, etc. of the cognitive processor 32. The particular class structure of these data formats should not be considered a limitation of the invention.

Working memory 210 extracts the information from the collection of property bags during a configurable time window to construct snapshots of the autonomous vehicle and various agents. These snapshots are published with a fixed frequency and pushed to subscribing modules. The data structure created by working memory 210 from the property bags is a “State” data structure which contains information organized according to timestamp. A sequence of generated snapshots therefore encompass dynamic state information for another vehicle or agent. Property bags within a selected State data structure contain information about objects, such as other agents, the autonomous vehicle, route information, etc. The property bag for an object contains detailed information about the object, such as the object's location, speed, heading angle, etc. This state data structure flows throughout the rest of the cognitive processor 32 for computations. State data can refer to autonomous vehicle states as well as agent states, etc.

The hypothesizer module(s) 212 pulls State data from the working memory 210 in order to compute possible outcomes of the agents in the local environment over a selected time frame or time step. Alternatively, the working memory 210 can push State data to the hypothesizer module(s) 212. The hypothesizer module(s) 212 can include a plurality of hypothesizer modules, with each of the plurality of hypothesizer modules employing a different method or technique for determining the possible outcome of the agent(s). One hypothesizer module may determine a possible outcome using a kinematic model that applies basic physics and mechanics to data in the working memory 210 in order to predict a subsequent state of each agent 50. Other hypothesizer modules may predict a subsequent state of each agent 50 by, for example, employing a kinematic regression tree to the data, applying a Gaussian Mixture Model/Markovian mixture model (GMM-HMM) to the data, applying a recursive neural network (RNN) to the data, other machine learning processes, performing logic based reasoning on the data, etc. The hypothesizer modules 212 are modular components of the cognitive processor 32 and can be added or removed from the cognitive processor 32 as desired.

Each hypothesizer module 212 includes a hypothesis class for predicting agent behavior. The hypothesis class includes specifications for hypothesis objects and a set of algorithms. Once called, a hypothesis object is created for an agent from the hypothesis class. The hypothesis object adheres to the specifications of the hypothesis class and uses the algorithms of the hypothesis class. A plurality of hypothesis objects can be run in parallel with each other. Each hypothesizer module 212 creates its own prediction for each agent 50 based on the working current data and sends the prediction back to the working memory 210 for storage and for future use. As new data is provided to the working memory 210, each hypothesizer module 212 updates its hypothesis and pushes the updated hypothesis back into the working memory 210. Each hypothesizer module 212 can choose to update its hypothesis at its own update rate (e.g., rate h-Hz). Each hypothesizer module 212 can individually act as a subscription service from which its updated hypothesis is pushed to relevant modules.

Each hypothesis object produced by a hypothesizer module 212 is a prediction in the form of a state data structure for a vector of time, for defined entities such as a location, speed, heading, etc. In one embodiment, the hypothesizer module(s) 212 can contain a collision detection module which can alter the feedforward flow of information related to predictions. Specifically, if a hypothesizer module 212 predicts a collision of two agents 50, another hypothesizer module may be invoked to produce adjustments to the hypothesis object in order to take into account the expected collision or to send a warning flag to other modules to attempt to mitigate the dangerous scenario or alter behavior to avoid the dangerous scenario.

For each agent 50, the hypothesis resolver 118 receives the relevant hypothesis objects and selects a single hypothesis object from the hypothesis objects. In one embodiment, the hypothesis resolver 118 invokes a simple selection process. Alternatively, the hypothesis resolver 118 can invoke a fusion process on the various hypothesis objects in order to generate a hybrid hypothesis object.

Since the architecture of the cognitive processor is asynchronous, if a computational method implemented as a hypothesis object takes longer to complete, then the hypothesis resolver 118 and downstream decider modules 216 receive the hypothesis object from that specific hypothesizer module at an earliest available time through a subscription-push process. Time stamps associated with a hypothesis object informs the downstream modules of the relevant time frame for the hypothesis object, allowing for synchronization with hypothesis objects and/or state data from other modules. The time span for which the prediction of the hypothesis object applies is thus aligned temporally across modules.

For example, when a decider module 216 receives a hypothesis object, the decider module 216 compares the time stamp of the hypothesis object with a time stamp for most recent data (i.e., speed, location, heading, etc.) of the autonomous vehicle 10. If the time stamp of the hypothesis object is considered too old (e.g., pre-dates the autonomous vehicle data by a selected time criterion) the hypothesis object can be disregarded until an updated hypothesis object is received. Updates based on most recent information are also performed by the trajectory planner 220.

The decider module(s) 216 includes modules that produces various candidate decisions in the form of trajectories and behaviors for the autonomous vehicle 10. The decider module(s) 216 receives a hypothesis for each agent 50 from the hypothesis resolver 214 and uses these hypotheses and a nominal goal trajectory for the autonomous vehicle 10 as constraints. The decider module(s) 216 can include a plurality of decider modules, with each of the plurality of decider modules using a different method or technique for determining a possible trajectory or behavior for the autonomous vehicle 10. Each decider module can operate asynchronously and receives various input states from working memory 212, such as the hypothesis produced by the hypothesis resolver 214. The decider module(s) 216 are modular components and can be added or removed from the cognitive processor 32 as desired. Each decider module 216 can update its decisions at its own update rate (e.g., rate d-Hz).

Similar to a hypothesizer module 212, a decider module 216 includes a decider class for predicting an autonomous vehicle trajectory and/or behavior. The decider class includes specifications for decider objects and a set of algorithms. Once called, a decider object is created for an agent 50 from the decider class. The decider object adheres to the specifications of the decider class and uses the algorithm of the decider class. A plurality of decider objects can be run in parallel with each other.

The decision resolver 218 receives the various decisions generated by the one or more decider modules and produces a single trajectory and behavior object for the autonomous vehicle 10. The decision resolver can also receive various contextual information from evaluator modules 232, wherein the contextual information is used in order to produce the trajectory and behavior object.

The trajectory planner 220 receives the trajectory and behavior objects from the decision resolver 218 along with the state of the autonomous vehicle 10. The trajectory planner 220 then generates a trajectory message that is provided to the trajectory sender 222. The trajectory sender 222 provides the trajectory message to the autonomous vehicle 10 for implementation at the autonomous vehicle, using a format suitable for communication with the autonomous vehicle.

The trajectory sender 222 also sends the trajectory message to virtual controller 224. The virtual controller 224 provides data in a feed-forward loop for the cognitive processor 32. The trajectory sent to the hypothesizer module(s) 212 in subsequent calculations are refined by the virtual controller 224 to simulate a set of future states of the autonomous vehicle 10 that result from attempting to follow the trajectory. These future states are used by the hypothesizer module(s) 212 to perform feed-forward predictions.

Various aspects of the cognitive processor 32 provide feedback loops. A first feedback loop is provided by the virtual controller 224. The virtual controller 224 simulates an operation of the autonomous vehicle 10 based on the provided trajectory and determines or predicts future states taken by each agent 50 in response to the trajectory taken by the autonomous vehicle 10. These future states of the agents can be provided to the hypothesizer modules as part of the first feedback loop.

A second feedback loop occurs because various modules will use historical information in their computations in order to learn and update parameters. Hypothesizer module(s) 212, for example, can implement their own buffers in order to store historical state data, whether the state data is from an observation or from a prediction (e.g., from the virtual controller 224). For example, in a hypothesizer module 212 that employs a kinematic regression tree, historical observation data for each agent is stored for several seconds and used in the computation for state predictions.

The hypothesis resolver 214 also has feedback in its design as it also utilizes historical information for computations. In this case, historical information about observations is used to compute prediction errors in time and to adapt hypothesis resolution parameters using the prediction errors. A sliding window can be used to select the historical information that is used for computing prediction errors and for learning hypothesis resolution parameters. For short term learning, the sliding window governs the update rate of the parameters of the hypothesis resolver 214. Over larger time scales, the prediction errors can be aggregated during a selected episode (such as a left turn episode) and used to update parameters after the episode.

The decision resolver 218 also uses historical information for feedback computations. Historical information about the performance of the autonomous vehicle trajectories is used to compute optimal decisions and to adapt decision resolution parameters accordingly. This learning can occur at the decision resolver 218 at multiple time scales. In a shortest time scale, information about performance is continuously computed using evaluator modules 232 and fed back to the decision resolver 218. For instance, an algorithm can be used to provide information on the performance of a trajectory provided by a decider module based on multiple metrics as well as other contextual information. This contextual information can be used as a reward signal in reinforcement learning processes for operating the decision resolver 218 over various time scales. Feedback can be asynchronous to the decision resolver 218, and the decision resolver 218 can adapt upon receiving the feedback.

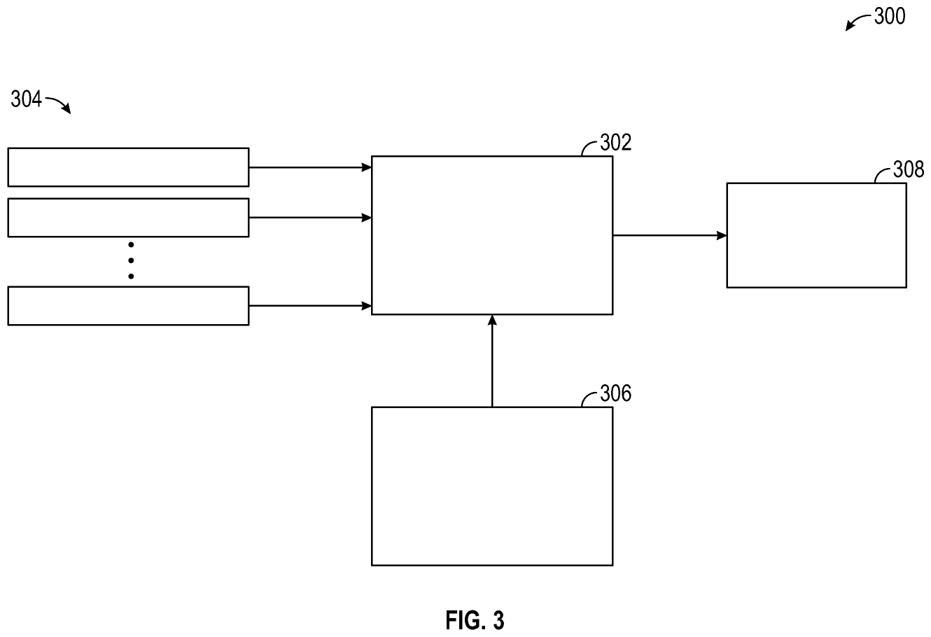

FIG. 3 shows a schematic diagram 300 of a hypothesis resolver 302 that operates to predict agent states, such as locations and speeds from a plurality of hypothesis objects or solutions that are provided to the hypothesis resolver 302. The hypothesis resolver 302 receives a plurality of solutions 304 (e.g., Solution 1, Solution 2, . . . , Solution N) from a plurality of hypothesizer modules (in this case, N modules). Each solution is a prediction of an action of an agent or agents using a prediction mechanism specific to the module. For example, one module may predict a trajectory for the agent based on a present location of the agent and a present speed of the object. Another module may predict a different trajectory for the agent based on traffic rules and their compliance, such as the presence of a stop sign, for example. In general, each module predicts a different solution or trajectory, and the plurality of trajectories are provided to the hypothesis resolver 302, which selects an optimal, most likely, or desired trajectory.

The hypothesis resolver 302 further receives an environmental state or environmental conditions of the autonomous vehicle from the state module 306. The environmental state or condition is taken into account when selecting the optimal solution. The environmental state of the vehicle can include, but is not limited to, a weather condition, a traffic pattern, traffic rules, a road condition, agent type, road type, road complexity, number of present agents, past solution selections, etc. The hypothesis resolver 302 selects an optimal solution for the given environmental state and provides this solution as output 308 to the cognitive processor 200. The cognitive processor can then use the selected solution to determine a trajectory for the autonomous vehicle.

The hypothesis resolver 302 undergoes a training process in order to be able to correctly select an optimal solution for different agent situations and different environmental conditions. In one embodiment, the hypothesis resolver 302 is operated in an offline or training mode in order to train the hypothesis resolver 302 in optimal selection of solutions.

In an offline mode, the training can be performed by training a neural network under simulations of multiple scenarios with multiple interacting agents. The different scenarios can include different environmental states, such as different weather conditions, different traffic patterns or conditions, etc. The simulation provides multiple solutions to the hypothesis resolver 302 under various different environmental states. Each solution predicts a state of an agent 50 at a selected time in the future and the hypothesis resolver 302 determines the suitability of each solution given the selected scenario and/or environmental state. The selected time in the future is generally about 2 seconds, but can be anywhere from about 1 second to about 10 seconds in the future in various embodiments.

Once the hypothesis resolver 302 selects a solution, the simulation is run to the selected future time to generate an actual or measured state. An error can be computed for each solution between the predicted state of the vehicle 10 (from the hypothesis resolver 302) and the actual or measured state of the vehicle (from the simulation). A reward or confidence value can then be assigned by the hypothesis resolver 302 to the solution based on the error. A high reward or confidence level is assigned when the selected solution that closely predicts the actions of the agent for the given environmental condition. On the other hand, a low reward or confidence level is assigned when the selected solution poorly predicts the actions of the agent for the given environmental condition.

In the present embodiment, the solution with the smallest error is selected as the optimal solution and is assigned a positive reward value. The exact reward value can be either manually selected given past training or computed at run time to avoid overfitting or always selecting the same solution. In some scenarios, one module will provide the majority of the optimal solutions, while the other modules provide solutions that cover edge cases. For these cases, the reward for the most used module needs to be reduced to a value in the range of 0.1-0.5 in order to counteract the tendency of a selection algorithm of the neural network to always select the module generating the most of the rewards. It is to be understood that the reward or confidence level is a function of many variables, such as the traffic pattern, the road conditions, the weather conditions, the road configuration, etc. A solution that closely predicts the future state of an agent under one road condition, for example, may provide a poor prediction of the future state of the agent under another road condition.

Once trained, the hypothesis resolver 302 can be used in an operating mode for real-case scenarios. The rewards or confidence levels assigned to the solutions can be used to select desired solutions in the real-case scenarios.

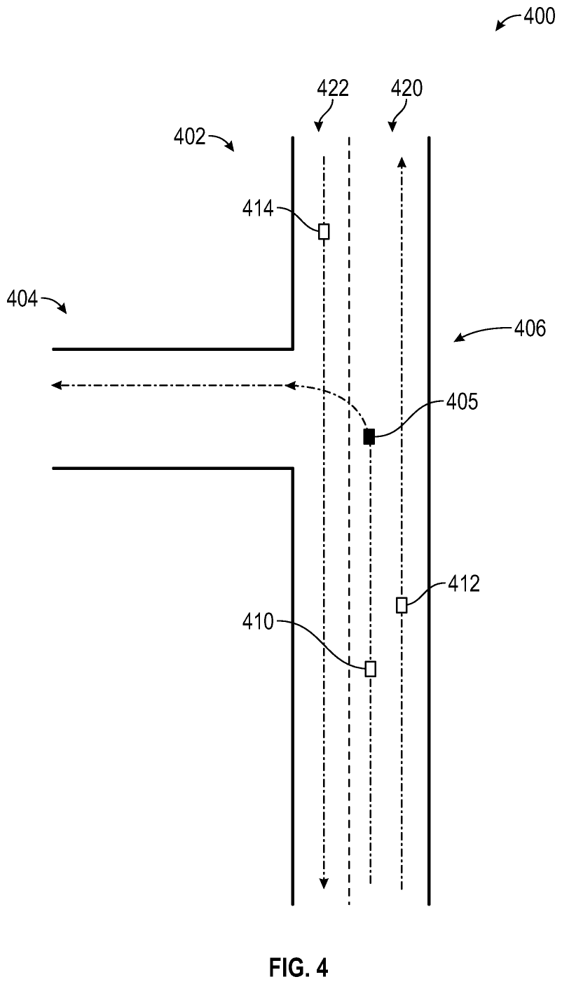

FIG. 4 shows an illustrative traffic scenario 400 suitable for use in training a hypothesis resolver. The illustrative traffic scenario 400 includes an intersection between a first road segment 402 and a second road segment 404 (e.g., a side street) that is perpendicular to the first road segment 402 and that ends at an intersection 406 between the first road segment 402 and the second road segment 404. The first road segment 402 includes two lanes for traffic heading in a first direction 420 (up the page) and at least one lane for traffic heading in a second direction 422 (down the page) opposite to the first direction.

Under the traffic scenario shown in FIG. 4, a first agent 410 (i.e., the autonomous vehicle 10) is driving in the first direction in the left-most of the first road segment 402 and a second agent 412 is driving in the first direction in the right-most of the first road segment 402. A third agent 414 is driving in the second direction. As the first agent 410 approaches the intersection 406, the first agent 410 performs a left turn as traffic permits. The hypothesis resolver 302 determines, among other things, whether the first agent 410 has to stop (e.g., at location 405) to yield to incoming traffic before turning left or can proceed with the left turn without stopping.

For illustrative purposes, two modules (e.g., Module A and Module B) are generating trajectories that are provided to the hypothesis resolver 302 for selection of an optimal trajectory. Module A generates a trajectory based on kinematic rules that assumes the first agent 410 will maintain the same speed and heading provided by present conditions. Module B generates a rules-based trajectory that operates under the rule that when the first agent 410 approaches an intersection, the first agent 410 will stop at the intersection if the first agent 410 has indicated a left turn intention with the left turn signal and another agent (i.e., the third agent 414) is approaching from the opposite direction. Accordingly, Module B will predict a left turn without stopping if the left turn signal is activated but no agent is approaching from the opposite direction.

Before approaching the intersection 406, the first agent 410 moves in a straight line at a constant speed and heading. Under these conditions, Module A generates the best trajectory. Once the first agent 410 approaches the intersection 406, where conditions are different, Module B now generates the best trajectory. The hypothesis resolver 302 is trained to select the trajectory that most fits the traffic situation of the agent, thereby minimizing the error associated with the agent at some time in the future.

During the training process, the hypothesis resolver initially randomly selects between the solution of Module A and the solution of Module B. This selection is repeated at a selected sampling rate. A typical sampling rate is about 20 Hz. At a selected time (e.g. about two seconds) after each selection, it is possible to compute the error between the predicted trajectory and the actual trajectory followed by the first agent 410. A simplest error is determined by a Euclidean distance between the predicted trajectory and the actual trajectory. In various embodiments, extensions with different error, reward, and/or training algorithms can be substituted with more complex or simpler alternatives without changing the structure of the hypothesis resolver 302.

At the selected time, the hypothesis resolver 302 determines if the previous selection was optimal or not. If the selection was optimal, then a reward signal is computed and provided to the neural network algorithm to reinforce the optimal selection. If the selection is non-optimal, then a negative reward signal is provided to the neural network algorithm to correct the mistaken decision. Over time, the hypothesis resolver will reduce the selection error and correctly select the optimal solution.

For the illustrative scenario, the hypothesis resolver selects Module A for the first agent over any straight segment of road. As the first agent approaches the intersection 406, its heading is kept constant while its speed changes. Since most of the time, the first agent 410 is driving in a straight line, then without previous experience of intersection scenarios, the hypothesis resolver 302 tends to continue selecting Module A, leading to higher error as the agent approaches the intersection. Over time, the hypothesis resolver 302 is able to correctly compute the transition point between selection of Module A for a straight segment of road and selection of Module B for an agent approaching an intersection with the intent to turn left.

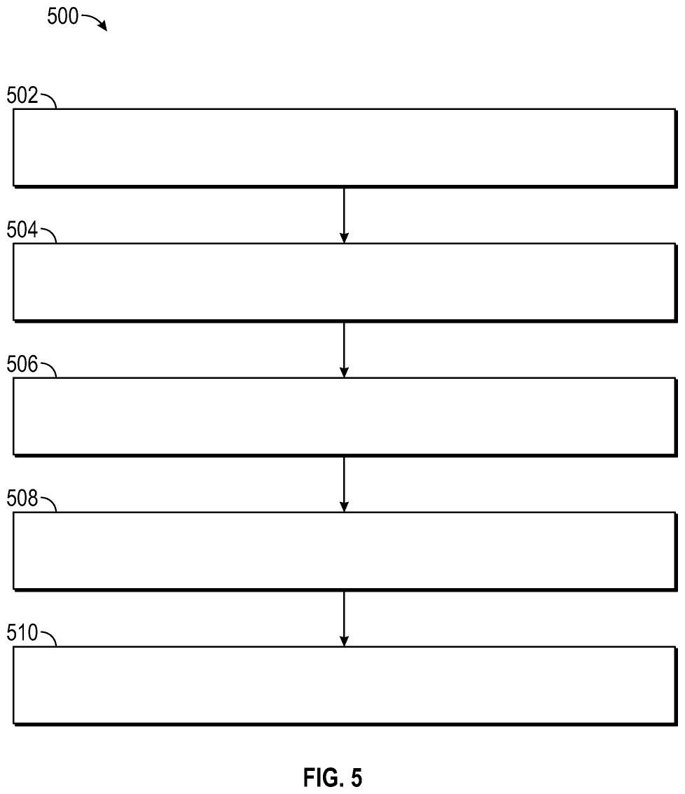

FIG. 5 shows a flowchart 500 illustrating a training mode of the hypothesis resolver, in an embodiment. In box 502, the environmental state is obtained, such as the traffic conditions, traffic rules, etc. In box 504, a solution is generated for one or more agents, the solution predicting a state or a trajectory of the one or more agents based on the environmental state. In box 506, an actual state or trajectory of the one or more agents is measured. In box 508, an error is assigned between the predicted state or trajectory and the actual state or trajectory. In box 510, a confidence level or reward is assigned to the solution for the particular environmental conditions.

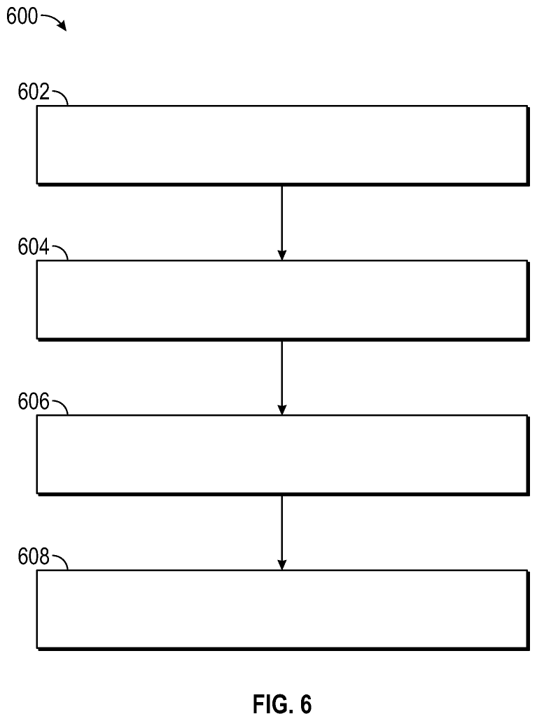

FIG. 6 shows a flowchart 600 illustrating an operating mode of the hypothesis resolver. In box 602, the environmental state is obtained. In box 604, a solution providing a highest reward or confidence level for the environmental state is selected. In box 606, the state or trajectory of one or more agents is predicted using the selected solution. In box 608, the autonomous vehicle is navigated using the predicted states or trajectories of the one or more agents.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an autonomous vehicle, comprising:
receiving a plurality of solutions for a future state of an agent at a hypothesis resolver;
receiving an environmental state at the hypothesis resolver;
selecting a solution from the plurality of solutions based on the environmental state and a reward associated with each of the solutions, the reward indicating a confidence level of the solution for the environmental state; and
navigating the autonomous vehicle based on the selected solution.

2. The method of claim 1, wherein the environmental state includes at least one of a weather condition, a traffic pattern, a traffic rule and a road condition.

3. The method of claim 1, further comprising training the hypothesis resolver during a training mode to associate rewards with each of the solutions for a selected environmental state.

4. The method of claim 3, further comprising training the hypothesis resolver during a training mode by predicting a state of the agent at a selected future time for a solution and the received environmental state, measuring the actual state of the agent at the selected future time, determining an error for the solution based on predicted state and the actual state, and assigning the reward to the solution based on the error.

5. The method of claim 4, wherein the reward is inversely proportional to the error.

6. The method of claim 4, further comprising adjusting the reward of a solution to avoid overfitting of the solution to the environmental state.

7. The method of claim 4, wherein the error is determined from a Euclidean distance between the predicted state and the actual state.

8. A system for operating an autonomous vehicle, comprising:
a plurality of solution modules that each provide a solution for a future state of an agent;
a state module that provides an environmental state;
a hypothesis resolver that receives the environmental state and the plurality of solutions, selects a solution from the plurality of solutions based on the environmental state and determines a reward for the solution, the reward indicating a confidence level of the solution for the environmental state; and
a navigation module for navigating the autonomous vehicle based on the selected solution.

9. The system of claim 8, wherein the environmental state includes at least one of a weather condition, a traffic pattern, a traffic rule and a road condition.

10. The system of claim 8, further comprising a neural network for training hypothesis resolver during a training mode to associate rewards with each of the plurality of solutions for a selected environmental state.

11. The system of claim 10, wherein the neural network trains the hypothesis resolver during the training mode by predicting a state of the agent at a selected future time for a solution and the received environmental state, measuring the actual state of the agent at the selected future time, determining an error for the solution based on predicted state and the actual state, and assigning the reward to the solution based on the error.

12. The system of claim 11, wherein the reward is inversely proportional to the error.

13. The system of claim 11, wherein the hypothesis resolver adjusts the reward of a solution to avoid overfitting of the solution to the environmental state.

14. The system of claim 11, wherein the error is determined from a Euclidean distance between the predicted state and the actual state.

15. An autonomous vehicle, comprising:
a plurality of solution modules that each provide a solution for a future state of an agent;
a state module that provides an environmental state;
a hypothesis resolver that receives the environmental state and the plurality of solutions, selects a solution from the plurality of solutions based on the environmental state and determines a reward for the solution, the reward indicating a confidence level of the solution for the environmental state; and
a navigation module for navigating the autonomous vehicle based on the selected solution.

16. The autonomous vehicle of claim 16, wherein the environmental state includes at least one of a weather condition, a traffic pattern, a traffic rule and a road condition.

17. The autonomous vehicle of claim 16, further comprising a neural network for training hypothesis resolver during a training mode to associate rewards with each of the plurality of solutions for a selected environmental state.

18. The autonomous vehicle of claim 17, wherein the neural network trains the hypothesis resolver during the training mode by predicting a state of the agent at a selected future time for a solution and the received environmental state, measuring the actual state of the agent at the selected future time, determining an error for the solution based on predicted state and the actual state, and assigning the reward to the solution based on the error.

19. The autonomous vehicle of claim 18, wherein the reward is inversely proportional to the error.

20. The autonomous vehicle of claim 18, wherein the hypothesis resolver adjusts the reward of a solution to avoid overfitting of the solution to the environmental state.
